(19) United States
(12) Patent Application Publication
(10) Pub. No.: US 2006/0277034 A1
(43) Pub. Date: Dec. 7, 2006

(54) Method and system for processing HRTF data for 3-D sound positioning

(76) Inventor: Ben Sferrazza, Sunnyvale, CA (US)

Correspondence Address: Sandeep Jaggi;LSI Logic Corporation, Intellectual Property Law Dept., 1621 Barber Lane, M/S D-106, Milpitas, CA, 95035, US

(21) Appl. No.: 11/142,726

(22) Filed: Jun. 1, 2005

(51) Int. Cl. G10L 19/00

(52) U.S. Cl. 704/200.1

(57) ABSTRACT

A method and system for processing for processing HRTF data for 3-D sound positioning. According to the present invention, a number of voices to be processed is determined, and a number of HRTF coefficients to be processed is determined based on the number of voices. According to the method and system disclosed herein, an M order minimum phase filter is implemented as a lower N order minimum phase filter (N<M), where the number of coefficients (N) to be processed dynamically changes based on the number of voices to be processed at a given time. As a result, an optimal implementation of the minimum phase filter reproduces a desired magnitude response while reducing power consumption.

### FIELD OF THE INVENTION

The present invention relates to sound processing, and more particularly to a method and system for processing HRTF data for 3-D sound positioning.

### BACKGROUND OF THE INVENTION

The sound pressure that an arbitrary source x(t) produces at the ear drum is represented by the impulse response h(t) from the source to the ear drum. This is called the Head-Related Impulse Response (HRIR), and its Fourier transform H(f) is called the Head Related Transfer Function (HRTF). The HRTF models the sound filtering characteristics of the human pinna (projecting portion of the external ear) and torso (a human trunk) and captures the physical cues to the source localization. Once the HRTF for the left ear and the right ear are known, accurate binaural signals can be synthesized from a monaural source. Most HRTF measurements essentially reduce the HRTF to a function of a sound's azimuth, elevation, and frequency.

FIG. 1A is a conceptual illustration, of 3-D sound filtering using HRTF. Implementing 3-D sound positioning requires filtering a monophonic, non-directional input sound 10 with left and right ear HRTFs 18a and 18b that are associated with a particular radial angle 12 from a listener's position 16. In some sound processing environments, this radial angle 12 is azimuthal. Typically, a software program inputs the sound 10 to a sound processor, and specifies the angle 12 at which the input sound 10 should be filtered in order to be perceived as if it originated from that position. When the left ear HRTF 18a and right ear HRTF 18b associated with the specified angle 12 are applied to the input sound source 10, an Interaural Intensity Difference (IID) and an Interaural Time Difference (ITD) is established between the sounds that arrive at the listener's ears. The IID represents the difference in the intensity of the sound reaching the two ears, while the ITD represents the difference between the time that the sound reaches the left and right ears. Each HRTF includes a magnitude response and the phase response, where the magnitude response of the HRTF includes the IID, which is frequency dependent; and the phase response of the HRTF includes the ITD, which is frequency dependent.

The complexity of the HRTF filters leads to several problems. The large number of taps (i.e. HRTF coefficients) necessary to accurately model the HRTF leads to a great deal of computation and, hence, high power consumption. Attempting to find an acceptable balance between filter accuracy and low power, low filter order can be challenging.

In some sound processor architectures, minimum phase versions of the HRTF filters, also referred to as minimum phase filters, are used that no longer have the ITD inherent in the phase response of the filters. Instead, an ITD delay 22, representing the average group delay of each HRTF, is used to artificially insert the ITD by delaying the contralateral (far) ear's input sound sequence to the appropriate HRTF 18 by a number of samples. When designing a 3-D sound system, a designer may choose a particular library of HRTF measurements from different sources on the basis of user preference or behavioral data.

FIG. 1B is a block diagram graphically illustrating how minimum phase versions HRTF measurements are conventionally stored. Although many formats are available for storing a library of HRTF measurements 30, the library 30 typically includes the left HRTF 18a, the right HRTF 18b, and optionally the ITD 22 for each allowable angle increment of the input sound 12 from 0 and 360 degrees. Each HRTF 18 typically comprises some number of HRTF coefficients, or ”coefficients.” For example, thirty-two 16-bit coefficients are not uncommon. Rather than being stored, the ITD 22 may be calculated directly from the angle 12 specified for the input sound 10 during sound processing. Whether the ITD 22 is stored or calculated, what is important to note is that for whatever increment the source angle 12 may be specified, that same increment is used to select the ITD 22.

A problem with minimum phase HRTF filters is that they consume a great deal of power. In designs that strive for a low-power architecture, filters that provide power benefits are imperative.

Another conventional solution includes the use of non-minimum phase HRTF filters and sound processors. Such filters may be HRTFs that preserve the original ITD information in the phase response. An advantage of using such filters is not needing to artificially insert the ITD. A problem with non-minimum phase filters is that implementing HRTFs require very high order filters to get adequate quality or comparable quality to a minimum-phase filter of lower-order. This is unacceptable for low-power 3-D sound hardware.

Alternatively, linear phase filters can be used to construct the HRTFs. A linear phase filter has the advantage of having no phase difference, and hence no ITD, between left and right ear HRTFs. Using linear phase filters allows the ITD to be artificially inserted with high precision. A problem with linear phase filters is that they still fall short of minimum phase filters with regard to accurate HRTF magnitude response reproduction. Since it is the HRTF filtering that consumes the large majority of power consumption for 3-D sound positioning, it is most critical to provide the best magnitude response for a low order filter. Minimum phase filters provide this facility.

In most 3-D sound processors that implement HRTF-based 3-D sound positioning, multiple simultaneous sounds (or voices as they are referred to) are programmable and can be independently positioned. Existing implementations, or solutions, would likely impose the processor's HRTF implementation on all voices. If 32-tap minimum-phase HRTFs are used for 3-D sound positioning, all voices would use such filters. Although a 32-tap minimum-phase HRTF filter is an ideal implementation for a single voice and would offer low-power, low-computation benefits, it offers no flexibility in reducing computational requirements and power consumption when several concurrent voices are running. For a system that may have more than 64 simultaneous voices, having a fixed HRTF implementation is far too rigid and the low-power, low-computation benefits of the fixed minimum-phase HRTF 3-D sound positioning implementation is diminished if most voices are running concurrently.

Accordingly, what is needed is an improved method and system for processing HRTF data for 3-D sound positioning. The present invention addresses such a need.

### BRIEF SUMMARY OF THE INVENTION

The present invention provides a method and system for processing HRTF data for 3-D sound positioning. According to the present invention, a number of voices to be processed is determined, and a number of HRTF coefficients to be processed is determined based on the number of voices.

According to the method and system disclosed herein, an M order minimum phase filter is implemented as a lower N order minimum phase filter (N<M), where the number of coefficients (N+1) to be processed dynamically changes based on the number of voices to be process at a given time. As a result, an optimal implementation of the minimum phase filter reproduces a desired magnitude response while reducing power consumption.

### BRIEF DESCRIPTION OF SEVERAL VIEWS OF THE DRAWINGS

FIG. 1A is a conceptual illustration of 3-D sound filtering using HRTF.

FIG. 1B is a block diagram graphically illustrating how minimum phase versions HRTF measurements are conventionally stored.

FIG. 2 is a diagram illustrating an M order minimum phase filter 200 that is implemented as a lower N order minimum phase filter, in accordance with a preferred embodiment of the present invention.

FIG. 3 is a diagram illustrating a sound processing system for processing HRTF data for 3-D sound positioning in accordance with a preferred embodiment of the present invention.

FIG. 4 is a flow diagram illustrating a computer-implemented method for processing HRTF data for 3-D sound positioning in accordance with a preferred embodiment of the present invention.

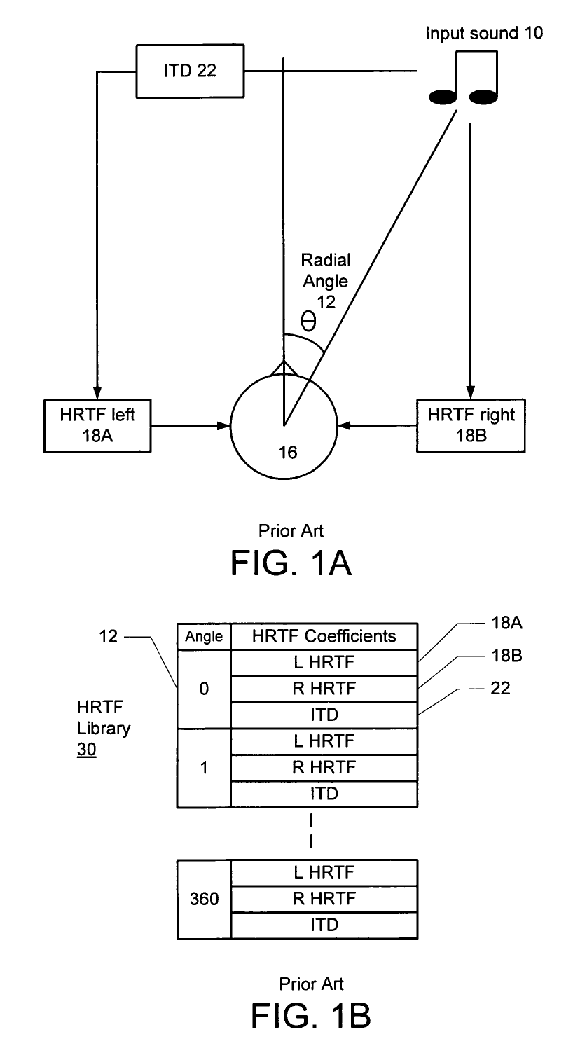

### DETAILED DESCRIPTION OF THE INVENTION

The present invention relates to a method and system for processing HRTF data for 3-D sound positioning. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides a method and system for processing HRTF data for 3-D sound positioning, where an M order minimum phase filter is implemented as a lower N order minimum phase filter (where N<M) by using the first N+1 coefficients of the M+1 coefficients. The number of coefficients (N+1) to be processed dynamically changes based on the number of voices to be processed at a given time. As a result, an optimal implementation of the minimum phase filter reproduces a desired magnitude response while reducing power consumption.

Due to the complexity of the HRTF filters necessary for accurate 3-D sound positioning, high order filters are required to model the frequency response with any accuracy. According to the present invention, minimum phase filters provide the most optimal solution when using a particular number of coefficients, which reproduces a desired magnitude response while reducing power consumption.

A minimum phase filter H(z) is a filter that has all of its poles and zeros contained in the unit circle (i.e. |z|<1). A consequence of this is that all minimum phase filters and their inverses are stable filters. A property of a minimum phase filter's impulse response hₘᵢₙ₍ₙ₎ is that it decays no more slowly than any non-minimum phase impulse response hᵢ₍ₙ₎ that has the same magnitude response. This behavior is illustrated by the following equation.
Σ(n=0 . . . M)|hₘᵢₙ(n)|²>=Σ(n=0 . . . M)|hᵢ(n)|², M=0, 1, 2,

The equation indicates that a minimum phase filter has the most optimal concentration of energy towards the first M+1 coefficients of its impulse response over any non-minimum phase impulse response with the same magnitude response. In other words, a minimum phase filter will most faithfully reproduce a desired magnitude response with the use of M+1 coefficients, where M is the filter order. Although there are varying degrees of error between minimum phase filters, and although not all minimum phase filters are created equally, a minimum phase filter will be no worse than a non-minimum phase filter in its ability to reproduce a desired magnitude response.

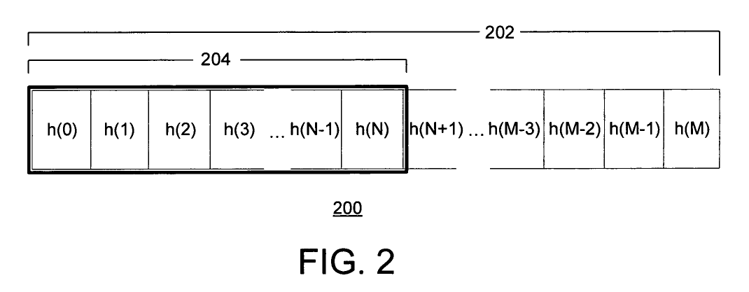

FIG. 2 is a diagram illustrating an M order minimum phase filter 200 that is implemented as a lower N order minimum phase filter, in accordance with a preferred embodiment of the present invention. The M order minimum phase filter 200 includes M+1 coefficients 202, where the M+1 coefficients 202 are stored in a memory, preferably an HRTF ROM. The first N+1 coefficients 204 (where N<M) are processed to provide the most optimal concentration of energy towards time 0 over any non-minimum phase filter also with N+1 coefficients and the same magnitude response. In other words, despite storing the M+1 coefficients for the M order minimum phase filter, an optimal lower N order is used to process 3-D voices by using the first N+1 coefficients.

N is based on the number of voices (i.e. enabled voices to be processed at a given time) such that the number of coefficients that are processed dynamically changes as the number of voices changes. In a specific embodiment, the number of coefficients used are inversely proportional to the number of voices. For example, when a greater number of voices are used at a given time, a fewer number of coefficients are processed. As such, because fewer coefficients are processed, less computation per voice is required. Accordingly, less power is consumed. When a fewer number of voices is used at a given time, a greater number of coefficients are processed. As a result, minimum phase filters are used to implement variable order HRTF filters for low-power 3-D sound positioning.

Accordingly, the stored M+1 coefficients of the order M minimum phase HRTF filters are ideal, because they most faithfully reproduce the desired magnitude responses of the HRTFs and they are adaptable to low-power applications when N+1 coefficients are used. In other words, storing M+1 coefficients allows for the optimal use of lower order HRTF filters and allows for the reduction of power consumption.

For a design that stores 32 coefficients for each minimum phase HRTF filter, the first n coefficients (where n<32) of the filters should be used to reduce the computation to n/32 of the original filter, allowing for various levels of low-power operation. In accordance with the present invention, the value n is dependent on the number of 3-D voices (or sounds) that are currently enabled and being processed. Since the number of enabled voices that is actively being processed and filtered increases the power consumption, an inverse relationship can be used to determine the filter order to use. Although reducing the filter order may introduce more 3-D positioning error, this inherent error will be less perceptible when several voices are playing simultaneously than if a single isolated voice were being played.

Suppose that a 3-D sound processor allows for 64 simultaneous voices. The 3-D sound processor stores 32-tap (i.e. 32-coefficients) left and right ear HRTF filters for each of the allowable positions (represented by a radial angle in the design considering the use of the invention). Preferably, all voices use the left and right ear 32-tap HRTF filters in order to position the sound, regardless of how many voices are simultaneously being processed. An example implementation of this invention would be to reduce the HRTF filter order by 1 for every 4 voices. If 1, 2, 3, or 4 voices are concurrently running, the full 32-tap filters will be used. If 4, 5, 6, or 7 voices are operating simultaneously, the first 31 taps of each filter will be used for all voices. If 61, 62, 63, or 64 voices are running then the first 16 taps of each filter will be used for all voices. Therefore, when all 64 voices are running simultaneously, the original 32-tap filter is reduced in half. This allows 64 voices using 16-tap filters to operate with roughly the same computational requirements and power consumption as 32 voices using 32-tap filters. The savings in computation and power is largely appreciable, while the reduction in 3-D sound position quality with so many concurrent voices is hardly noticeable.

Minimum phase filters provide a significant savings in area and power. Because the minimum phase filter is an optimal solution, it requires far fewer coefficients to be processed over a non-minimum phase filter with an equivalent magnitude response. Minimum phase filters also allow an optimal and efficient means of using variable, lower order HRTFs for performing 3-D sound positioning under different low-power modes of operation depending on the number of voices.

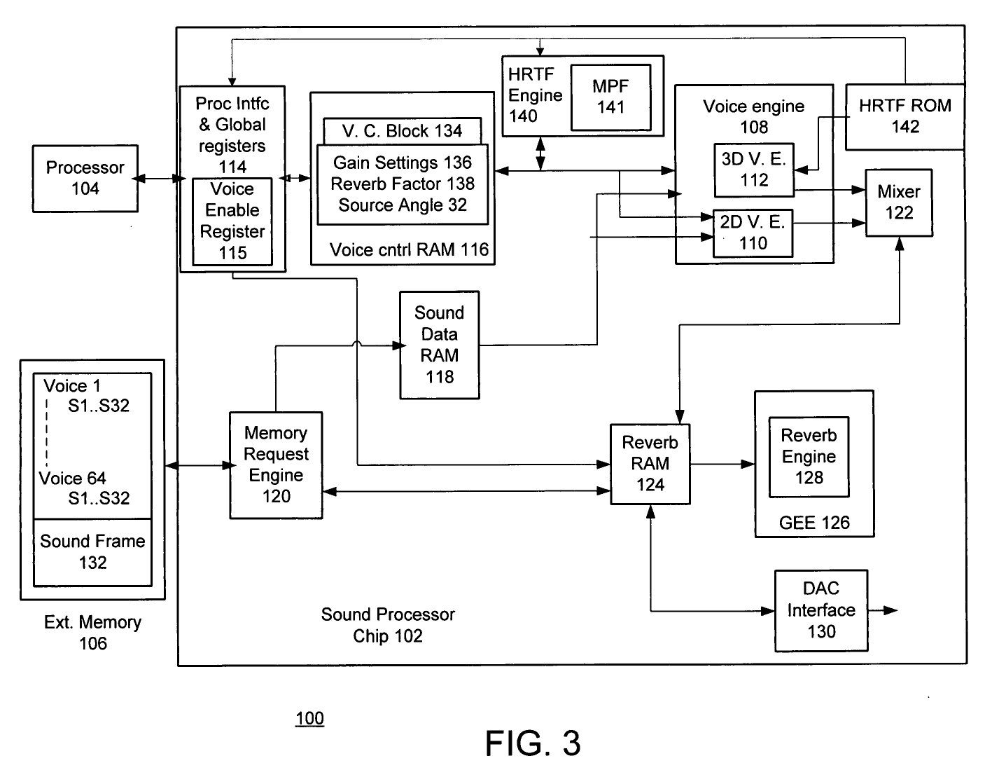

FIG. 3 is a diagram illustrating a sound processing system for implementing asymmetric HRTF/ITD storage in accordance with a preferred embodiment of the present invention. The sound processing system 100 includes a sound processor chip 102 that interacts with an external processor 104 and external memory 106. The sound processor chip 102 includes a voice engine 108, which optionally includes separate 2-D and 3-D voice engines 110 and 112. The sound processor chip 102 also includes an HRTF engine 140, minimum phase filters 141, an HRTF ROM 142, a processor interface and global registers 114, a voice enable register 115, a voice control RAM 116, a sound data RAM 118, a memory request engine 120, a mixer 122, a reverberation RAM 124, a global effects engine 126, which includes a reverberation engine 128, and a digital-to-analog converter (DAC) interface 130.

Sound is input to the sound processor chip 102 from the external memory 106 as a series of sound frames 132. Each sound frame 132 comprises sixty-four voices, and each voice includes thirty-two samples. In accordance with the present invention, a portion of the 64 voices (e.g. 16 voices) are 3-D voices, and these 3-D voices are processed by the minimum phase filters. The voice engine 108 processes each of the sixty-four voices of a frame 132 one at a time. A voice control block 134 stored in the voice control RAM 116 stores the settings that specify how the voice engine 108 is to process each of the sixty-four voices. The voice engine 108 begins by reading the voice control block 134 to determine the location of the input sound and sends a request to the memory request engine 120 to fetch the thirty-two samples of the voice being processed. The thirty-two samples are then stored in the sound data RAM 118 and processed by the voice engine 108 according to the contents of the corresponding control block 134.

The settings stored in the voice control block 134 include gain settings 136, the reverberation factor 138, and the source angle 12 used by the present invention. During processing of the sound, the contents of the control block 134, including the source angle 12, are altered by a high-level program (not shown) running on the processor 104. The processor interface 114 accepts the commands from the processor 104, which are first typically translated down to AHB bus protocol.

The voice engine 108 reads the values from the control block 134 and applies the gain and reverberation factors 136 and 138 to produce attenuated values for both channels. The 3-D voice engine 112 uses the source angle 12 to select an ITD value 22, and the ITD value 22 is then applied to the sound samples. The 3-D voice engine 112 also processes the sound sample with an HRTF from the HRTF ROM 142 that is associated with the HRTF region 40 in which the source angle falls, as described below.

After the 3-D and 2-D voice engines 110 and 112 process the sound samples, the values are then sent to the mixer 122, which maintains different banks of memory in the reverb RAM 124, including a 2-D bank, a 3-D bank, and a reverb bank (not shown) for storing processed sound. After all the samples are processed for a particular voice, the global effects engine 126 inputs the data from the reverb RAM 124 to the reverb engine 128. The global effects engine 126 mixes the reverberated data with the data from the 2-D and 3-D banks to produce the final output. This final output is input to the DAC interface 130 for output to a DAC to deliver the final output as audible sound.

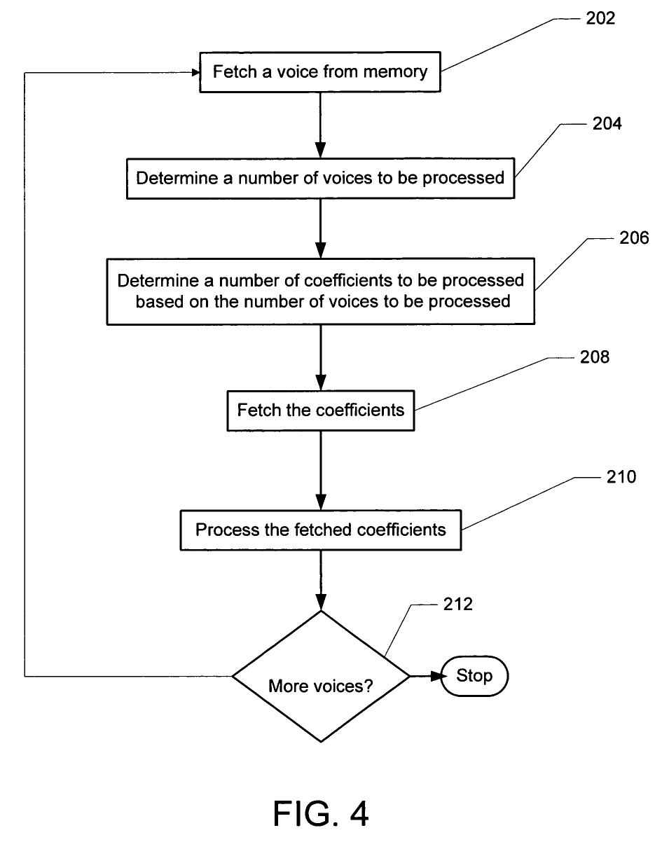

FIG. 4 is a flow diagram illustrating a computer-implemented method for processing HRTF data for 3-D sound positioning in accordance with a preferred embodiment of the present invention. Referring to both FIGS. 3 and 4, the process assumes that a set of M+1 coefficients have been prestored in the HRTF ROM 142 for each multiple-degree increment. The process performed by sound processor 102 begins in step 202 when a voice is fetched from memory 106 along with a specified source angle 12 from the voice control block 134 for processing by the 3-D voice engine 112. An ITD value 22 is selected by the 3-D voice engine 112 based directly on the source angle increment, which is a programmed value. As stated above, the ITD value 22 may be either calculated in real-time directly from the source angle increment, or a set of ITD values 22 corresponding to all of the source angle increments may be stored in the HRTF ROM 142.

In step 204, a number of voices to be processed is determined by the HRTF engine 140. The voices are preferably 3-D voices. The number of voices, i.e., those voices that are enabled at a given time, are specified by the voice enable register 115 in the global register 114. In step 206, a number of coefficients to be processed are determined by the HRTF engine 140, based on the number of voices to be processed. M+1 coefficients are stored in the HRTF ROM 142. The number of coefficients that are stored (i.e. M+1) is a predetermined number that is based on the maximum number that may be required by the sound processor 102 at a given instance. The number of coefficients to be processed (i.e. N+1) is less than total number of coefficients stored in the HRTF ROM 142.

In a preferred embodiment, the HRTF engine 140 reduces the filter order (i.e. the number of coefficients to be processed) automatically based on the number of concurrent voices to reduce power consumption. In an alternative embodiment, the filter order may be manually adjusted by a user. In an alternative embodiment, whether reduced automatically or manually, the number of HRTF coefficients to be processed for a particular voice may be selectable. In other words, the filter order may be reduced on a per-voice basis, since it may be more important that a particular voice (which is of higher quality or of more significance to the environment) be filtered with a higher order filter, while other voices that are running concurrently can use lower order filters to reduce the overall power. In yet another alternative embodiment, the filter order may be set by a global setting, as a register stored in processor interface and global registers 114 for instance. A global field may be written to manually change the filter order of all 3D voices. This global field could specify the precise filter order used by all 3D voices, or could be one of several predefined power states (e.g. ”High Power”/“High Quality”=32 taps, ”Medium Power”/”Medium Quality”=24 taps, and ”Low Power”/“Low Quality”=16 taps).

In a step 208, the HRTF engine 140 fetches the N+1 coefficients from the HRTF ROM 142. Accordingly, the number of coefficients to be processed dynamically changes based on the number of voices to be processed at a given time. In step 210, the HRTF engine 140 processes the fetched N+1 coefficients. Specifically, the 3-D voice engine 112 processes the voices and filters the voices using the using the N+1 coefficients of minimum phase filters 141 in the HRTF engine 140. If there are more voices to process in step 212, the process continues. Otherwise, the process ends.

A method and system for reducing storage requirements for processing HRTF data for 3-D sound positioning has been disclosed. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for processing HRTF data for 3-D sound positioning, the method comprising:
determining a number of voices to be processed; and
determining a number of HRTF coefficients to be processed based on the number of voices.

2. The method of claim 1 further comprising:
storing a first number of the HRTF coefficients in a memory; and
fetching a second number of the HRTF coefficients from the memory, wherein the second number is less than the first number.

3. The method of claim 2 further comprising processing the fetched coefficients.

4. The method of claim 3 further comprising filtering the voices with the fetched coefficients, wherein an M order minimum phase filter is implemented as a lower N order minimum phase filter.

5. The method of claim 1 wherein the number of HRTF coefficients that are to be processed changes as the number of voices changes.

6. The method of claim 1 wherein the number of HRTF coefficients used is inversely proportional to the number of voices.

7. The method of claim 1 wherein the determining a number of HRTF coefficients to be processed is an automatic process.

8. The method of claim 1 wherein the determining a number of HRTF coefficients to be processed is a manual process.

9. The method of claim 1 wherein the number of HRTF coefficients to be processed for a particular voice is selectable.

10. The method of claim 1 wherein the voices to be processed are 3-D voices.

11. A system for processing HRTF data for 3-D sound positioning, the system comprising:
a register containing a value representing a number of voices to be processed; and
means for determining a number of HRTF coefficients to be processed based on the number of voices.

12. The system of claim 11 wherein means for determining a number of HRTF coefficients to be processed is an automatic process.

13. The system of claim 12 wherein means for determining a number of HRTF coefficients to be processed is performed by an engine.

14. The system of claim 11 wherein means for determining a number of HRTF coefficients to be processed is a manual process.

15. The system of claim 14 wherein means for determining a number of HRTF coefficients to be processed is performed by a user.

16. The system of claim 11 wherein the number of HRTF coefficients to be processed for a particular voice is selectable.

17. The system of claim 11 further comprising:
a memory that stores a first number of the HRTF coefficients; and
an engine for fetching a second number of the HRTF coefficients from the memory, wherein the second number is less than the first number.

18. The system of claim 11 further comprising a plurality of filters that filter the voices with the fetched coefficients, wherein an M order minimum phase filter is implemented as a lower N order minimum phase filter.

19. The system of claim 11 wherein the number of HRTF coefficients that are to be processed changes as the number of voices changes.

20. The system of claim 11 wherein the number of HRTF coefficients used is inversely proportional to the number of voices.

21. The method of claim 11 wherein the voices to be processed are 3-D voices.

22. A sound processor for processing HRTF data for 3-D sound positioning, the processor comprising:
a 3-D voice engine for processing 3-D voices; and
a minimum phase filter coupled to the 3-D voice engine, wherein the minimum phase filter filters the 3-D voices.

23. The processor of claim 22 wherein the minimum phase filter is an M order minimum phase filter that is implemented as a N order minimum phase filter, wherein N is less than M.

24. The processor of claim 22 wherein the M order minimum phase filter filters the voices with HRTF coefficients, wherein the number of HRTF coefficients used is based on the number voices.

25. The processor of claim 22 wherein the number of HRTF coefficients used is inversely proportional to the number of voices.

26. The processor of claim 22 wherein a first number of the HRTF coefficients are stored in a memory, and wherein a second number of the HRTF coefficients are fetched from the memory, wherein the second number is less than the first number.
